(19) United States
(12) Patent Application Publication
(10) Pub. No.: US 2007/0046230 A1
(43) Pub. Date: Mar. 1, 2007

(54) Information processing apparatus and fan control method

(75) Inventor: Tomonori Tsutsui, Ome-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/500,182

(22) Filed: Aug. 7, 2006

(30) Foreign Application Priority Data
Aug. 30, 2005 (JP) 2005-249555

(51) Int. Cl. H02P 7/00

(52) U.S. Cl. 318/268; 318/599

(57) ABSTRACT

According to one embodiment, an information processing apparatus includes a main body, a heating device provided in the main body, a cooling fan provided in the main body, which cools the heating device, and a fan control unit provided in the main body, which supplies the cooling fan with a control signal having a first value for rotating the cooling fan at a given rotation speed that is higher than a target rotation speed, and which supplies the cooling fan with a control signal having a second value for rotating the cooling fan at the target rotation speed when a rotation speed of the cooling fan reaches a given rotation speed which is lower than the target rotation speed and which allows the cooling fan to rotate at a constant speed.

### CROSS-REFERENCE TO RELATED APPLICATIONS

This application is based upon and claims the benefit of priority from Japanese Patent Application No. 2005-249555, filed Aug. 30, 2005, the entire contents of which are incorporated herein by reference.

### BACKGROUND

1. Field

One embodiment of the invention relates to an information processing apparatus such as a personal computer. More specifically, the embodiment relates to an information processing apparatus having a cooling fan and a fan control method applied to the apparatus.

2. Description of the Related Art

Various portable personal computers such as a laptop computer and a notebook computer have recently been developed. This type of personal computer includes a heating device such as a central processing unit (CPU), a display controller, a hard disk drive and a bus bridge device.

A cooling fan is known as a cooling mechanism for cooling the heating device described above.

Jpn. Pat. Appln. KOKAI Publication No. 9-198166 discloses a computer for controlling the speed of a fan in accordance with the temperature of a CPU. In this computer, the fan does not rotate when the temperature is lower than a given value but rotates when it reaches the value.

The rotation speed of a fan is usually set at a relatively high value in order to lower the temperature of a heating device with efficiency. When the fan rotates, it causes noise that makes a user uncomfortable.

Jpn. Pat. Appln. KOKAI Publication No. 8-328698 discloses a computer having a mode in which a CPU is cooled by rotating a fan and a mode in which the CPU is cooled without rotating the fan but by lowering the operation speed of the CPU. In the latter mode, the fan does not rotate and thus causes no noise that is offensive to a user.

Relatively great driving force is required to start to rotate a fan. Usually, the value of a control signal for rotating the fan at a given high rotation speed (startup rotation speed) needs to be supplied to the fan for a given period of time when the fan starts to rotate. After the rotation speed of the fan is maintained at the startup rotation speed, it is switched to a target rotation speed. The startup rotation speed depends upon the characteristics of the fan.

In the above fan control, however, the rotation speed of the fan rises from zero to a high startup rotation speed, which easily causes noise that makes a user uncomfortable.

When the target rotation speed is lower than the startup rotation speed, the rotation speed of the fan rises from zero to a high startup rotation speed and then lowers to the target rotation speed. This variation in rotation speed causes noise such as a swell.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view of an information processing apparatus according to an embodiment of the invention;

FIG. 2 is an exemplary block diagram illustrating a cooling control mechanism provided in the information processing apparatus shown in FIG. 1;

FIG. 3 is an exemplary chart of the rotation speed of a cooling fan, which is varied by silent fan control performed by the information processing apparatus shown in FIG. 1;

FIG. 4 is an exemplary graph showing a relationship between the temperature of a heating device and the rotation speed of a fan under normal fan control;

FIG. 5 is an exemplary graph showing a relationship between the temperature of the heating device and the rotation speed of the fan under silent fan control;

FIG. 6 is an exemplary graph of normal fan startup control;

FIG. 7 is an exemplary graph of silent fan startup control performed by the information processing apparatus shown in FIG. 1;

FIG. 8 is an exemplary graph of characteristics of the cooling fan used in the information processing apparatus shown in FIG. 1;

FIG. 9 is an exemplary diagram showing a concrete example of connection between a fan control unit and the cooling fan in the information processing apparatus shown in FIG. 1;

FIG. 10 is an exemplary block diagram of a system configuration of the information processing apparatus shown in FIG. 1;

FIG. 11 is an exemplary block diagram of a cooling control mechanism that is applied to the system configuration shown in FIG. 10;

FIG. 12 is an exemplary block diagram of a temperature sensor provided in the information processing apparatus shown in FIG. 1;

FIG. 13 is an exemplary block diagram illustrating a cooling control mechanism that is applied to a CPU provided in the information processing apparatus shown in FIG. 1;

FIG. 14 is an exemplary flowchart of a procedure for a cooling control operation that is applied to the CPU provided in the information processing apparatus shown in FIG. 1;

FIG. 15 is an exemplary table used in the information processing apparatus shown in FIG. 1;

FIG. 16 is an exemplary table of the rotation speeds of a fan used in the information processing apparatus shown in FIG. 1;

FIG. 17 is an exemplary graph showing a transition of the rotation speed of the fan when a cooling mode used in the information processing apparatus shown in FIG. 1 is a performance mode;

FIG. 18 is an exemplary table of fan control parameters used in the information processing apparatus shown in FIG. 1;

FIG. 19 is an exemplary flowchart illustrating a procedure for performing a cooling control process by the information processing apparatus shown in FIG. 1; and

FIG. 20 is an exemplary flowchart illustrating a procedure for a fan startup control process performed by the information processing apparatus shown in FIG. 1.

### DETAILED DESCRIPTION

Various embodiments according to the invention will be described hereinafter with reference to the accompanying drawings. In general, according to one embodiment of the invention, an information processing apparatus includes a heating device provided in a main body, a cooling fan provided in the main body, which cools the heating device, and a fan control unit provided in the main body, which supplies the cooling fan with a control signal having a first value for rotating the cooling fan at a given rotation speed that is higher than a target rotation speed, and which supplies the cooling fan with a control signal having a second value for rotating the cooling fan at the target rotation speed when a rotation speed of the cooling fan reaches a given rotation speed which is lower than the target rotation speed and which allows the cooling fan to rotate at a constant speed.

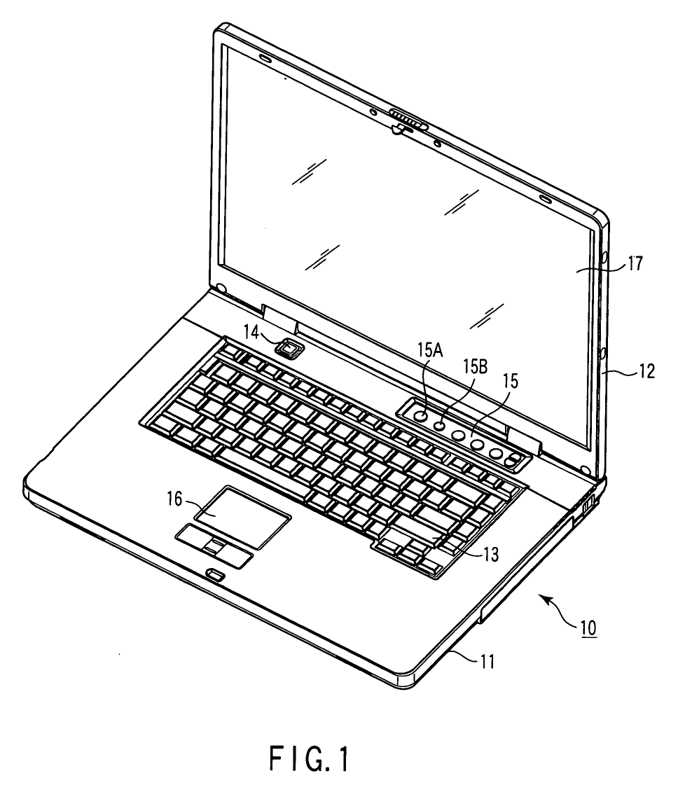

Referring first to FIG. 1, the configuration of an information processing apparatus according to the embodiment will be described. The information processing apparatus is implemented as, for example, a battery-operable, portable notebook personal computer 10.

FIG. 1 is a perspective view of the notebook personal computer 10 whose display unit is open.

The computer 10 includes a main body 11 and a display unit 12. The display unit 12 incorporates a display device that is formed of a liquid crystal display (LCD) 17. The display screen of the LCD 17 is located in almost the central part of the display unit 12.

The display unit 12 is attached to the main body 11 such that it can turn freely between an open position in which the top surface of the main body 11 is exposed and a closed position in which the top surface thereof is covered. The main body 11 is a thin box-shaped housing. The main body 11 includes various heating devices of a central processing unit (CPU), a display controller, a hard disk drive, a bus bridge device and the like.

A keyboard 13, a power button 14 for powering on/off the main body 11, an input operation panel 15 and a touch pad 16 are arranged on the top of the main body 11.

The input operation panel 15 is an input device for inputting an event corresponding to a depressed button and has a plurality of buttons for starting a plurality of functions. These buttons include buttons 15A and 15B for starting specific application programs.

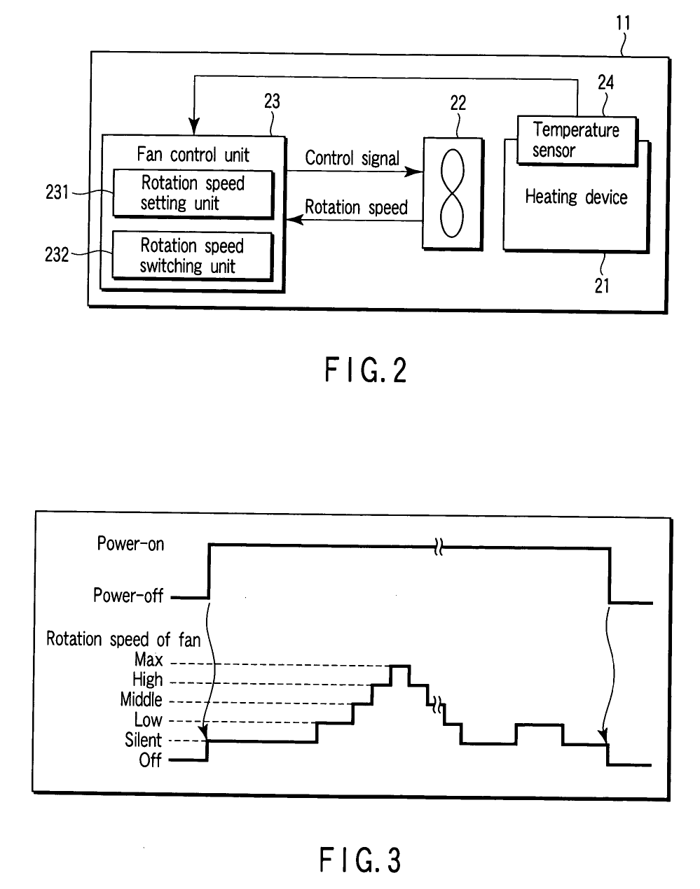

FIG. 2 shows an example of a cooling mechanism provided in the main body 11 of the computer 10. Referring to FIG. 2, the main body 11 includes a heating device 21, a cooling fan 22, a fan control unit 23 and a temperature sensor 24.

The heating device 21 is a device such as a CPU, a display controller, a hard disk drive and a bus bridge device. The cooling fan 22 is arranged close to the heating device 21 to cool the heating device 21. The cooling fan 22 cools the heating device 21 by air-cooling a heat sink that is thermally connected to the heating device 21 via a heat-receiving unit and the like. The cooling fan 22 also cools the heating device 21 by exhausting heated air from around the heating device 21. For example, the structure described in Japanese Patent No. 3637304 can be used for mounting the cooling fan 22.

The temperature sensor 24 is a sensor for sensing the temperature of the heating device 21. The temperature sensor 24 is provided, e.g., on the heating device 21.

The fan control unit 23 controls the cooling fan 22. The fan control unit 23 supplies the cooling fan 22 with a control signal to control the rotation speed (fan speed) of the cooling fan 22. A rotation speed signal (pulse signal) is fed back to the fan control unit 23 from the cooling fan 22. Using the rotation speed signal, the fan control unit 23 monitors the rotation speed of the cooling fan 22. The cooling fan 22 outputs two pulses per rotation as the rotation speed signal.

While the main body 11 is powered on, the fan control unit 23 continues to rotate the cooling fan 22 at not lower than a given rotation speed (first rotation speed), or the cooling fan 22 does not stop rotating. In other words, while the main body 11 is powered on, the minimum rotation speed of the cooling fan 22 is not zero but the first rotation speed. Since the first rotation speed is adequately low, the computer 10 can be made silent even though the cooling fan 22 rotates at the first rotation speed at all times.

If the temperature of the heating device 21 sensed by the temperature sensor 24 reaches a threshold value, the rotation speed of the cooling fan 22 is changed from the first rotation speed to a second rotation speed which is higher than the first rotation speed. If the heating device 21 is cooled and the temperature thereof sensed by the temperature sensor 24 becomes lower than the threshold value, the rotation speed of the cooling fan 22 is returned to the first rotation speed. While the main body 11 is powered on, the rotation speed of the cooling fan 22 is controlled on the basis of the first rotation speed. This fan control will be referred to as “silent fan control” hereinafter.

The first rotation speed is predetermined on the basis of the characteristic of the cooling fan 22. For example, the first rotation speed is the minimum value within a range capable of controlling the cooling fan 22, or a given value close to the minimum value.

The fan control unit 23 includes a rotation speed setting unit 231 and a rotation speed switching unit 232 to achieve the “silent fan control”.

Upon power-on of the main body 11, the rotation speed setting unit 231 performs a process of setting the rotation speed of the cooling fan 22 at the first rotation speed. When the main body 11 is powered on, a system BIOS performs a power on self test (POST) process. Then, an operating system is booted up. The rotation speed setting unit 231 sets the rotation speed of the cooling fan 22 at the first rotation speed during the POST process performed immediately after the main body 11 is powered on. In other words, the unit 231 rotates the cooling fan 22 at the first rotation speed before the operating system is booted up.

The rotation speed switching unit 232 performs a process of switching the rotation speed of the cooling fan 22 from the first rotation speed to the second rotation speed in accordance with the temperature of the heating device 21 sensed by the temperature sensor 24. Actually, the unit 232 controls the rotation speed of the cooling fan 22 not in two steps of the first and second rotation speeds but in five steps of the following first to fifth rotation speeds.

First rotation speed (Silent)

Second rotation speed (Low)

Third rotation speed (Middle)

Fourth rotation speed (High)

Fifth rotation speed (Max)

The rotation speed increases in the following order: Silent, Low, Middle, High and Max. A temperature region is assigned to each of the rotation speeds. The temperature of these temperature regions increases in the following order: Silent, Low, Middle, High and Max.

FIG. 3 shows the rotation speed of the cooling fan 22, which is varied by the “silent fan control”.

When the computer 10 is powered on (or resumed), the rotation speed of the cooling fan 22 is set at the first rotation speed (Silent). Immediately after the computer 10 is powered on, usually, the temperature of the heating device 21 is considerably low and thus the cooling fan 22 need not rotate. If, however, the cooling fan 22 rotates at the first rotation speed (Silent) immediately after the power-on, the temperature of the heating device 21 can be inhibited from increasing afterwards. Since, moreover, the first rotation speed is low, almost no noise is generated.

If the temperature of the heating device 21 increases to a threshold value corresponding to the temperature region of Low, the rotation speed of the cooling fan 22 is switched from the first rotation speed (Silent) to the second rotation speed (Low).

As described above, in accordance with the temperature of the heating device 21, the rotation speed of the cooling fan 22 is automatically switched among Silent, Low, Middle, High and Max.

The rotation speed of the cooling fan 22 can be controlled in six or more steps.

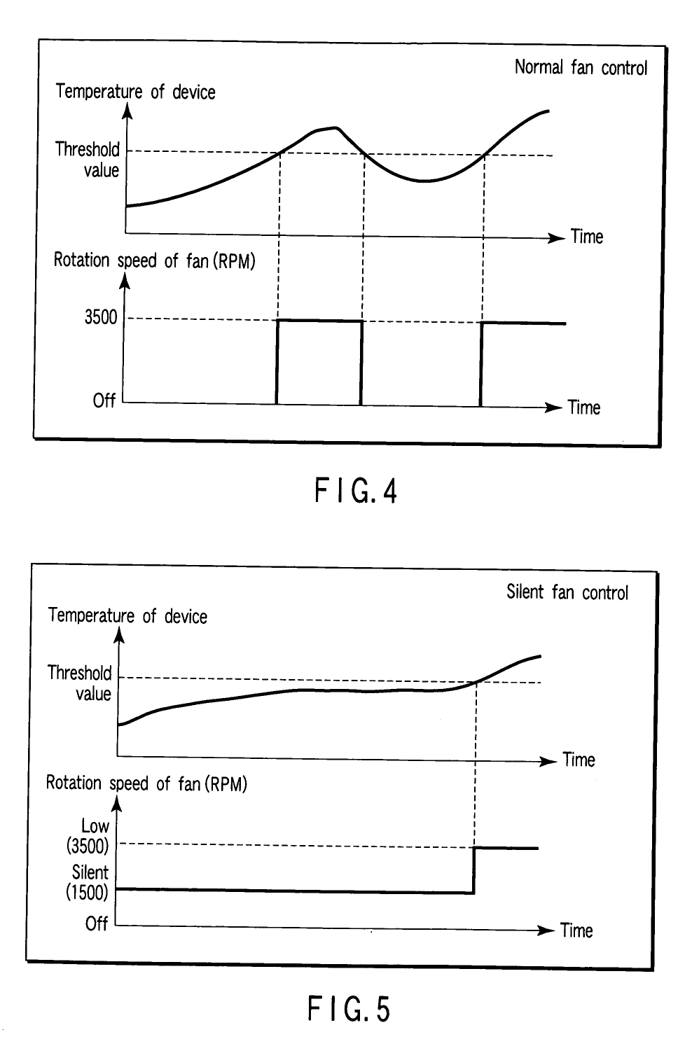

A relationship between the temperature of the heating device 21 and the rotation speed of the cooling fan 22 will be described with reference to FIGS. 4 and 5.

FIG. 4 shows a relationship between the temperature of the heating device 21 and the rotation speed of the cooling fan 22 under normal fan control. Under the normal fan control, the rotation speed varies among, for example, “Off”, “Low”, “Middle”, “High” and “Max”. The cooling fan 22 does not rotate (“Off”) until the temperature of the heating device 21 reaches the threshold value (e.g., 40 degrees) corresponding to “Low”. When the temperature reaches the threshold value, the rotation speed increases from zero to the rotation speed (e.g., 3500 rpm) corresponding to “Low”. Since the rotation speed suddenly increases by 3500 rpm, a relatively big noise occurs.

If the heating device 21 is cooled and its temperature lowers below the threshold value, the rotations speed is changed to zero. Thus, the rotation speed varies repeatedly between zero and 3500 rpm. Noise occurs like a continuous swell.

FIG. 5 shows a relationship between the temperature of the heating device 21 and the rotation speed of the cooling fan 22 under silent fan control.

The cooling fan 22 rotates at the first rotation speed (e.g., 1500 rpm) at all times even while the temperature of the heating device 21 is adequately low. The heating device 21 can thus be prevented from increasing in temperature. When the temperature of the heating device 21 reaches the threshold value (e.g., 40 degrees) corresponding to “Low”, the rotation speed increases to the rotation speed (e.g., 3500 rpm) corresponding to “Low”. Since, however, the increase of the rotation speed is only 1500 rpm, noise can be lessened more than that occurring when the rotation speed suddenly increases by 3500 rpm.

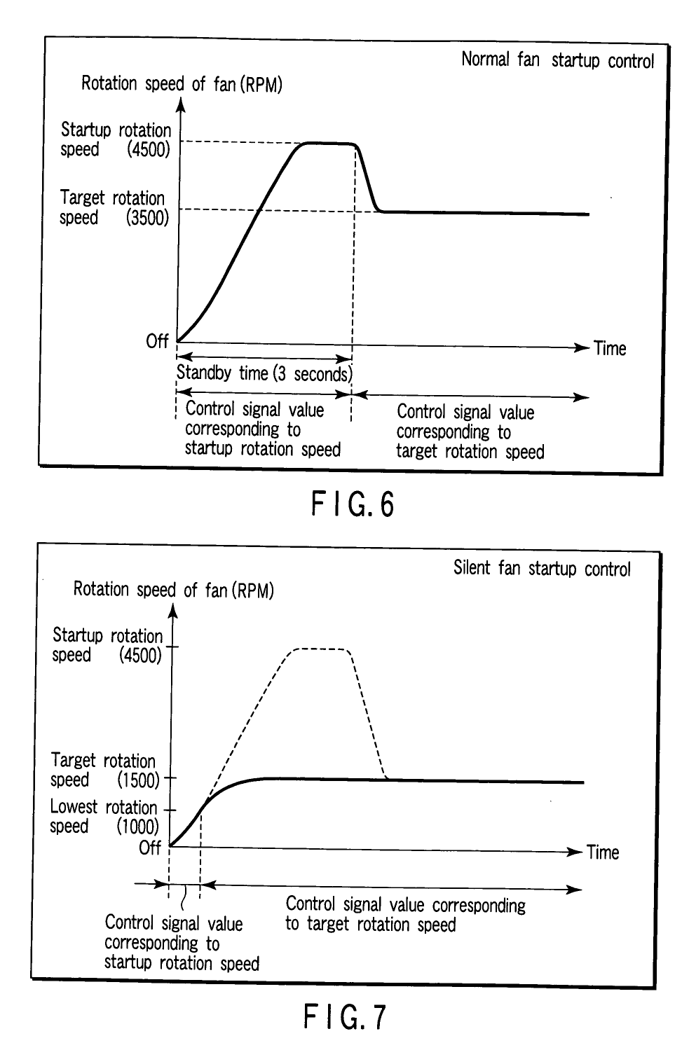

The fan startup control for shifting the cooling fan from its off state to its rotating state will be described with reference to FIGS. 6 and 7.

FIG. 6 shows a normal state of the fan startup control. Greater driving force is required to start to rotate the cooling fan 22.

In order to start to rotate the cooling fan at a target rotation speed (e.g., 3500 rpm), the fan has to be supplied with a control signal for a given period of time. This control signal has a, value (duty ratio or voltage) for rotating the fan at a rotation speed (startup rotation speed), which is higher than the target rotation speed (e.g., 3500 rpm). After the rotation speed of the cooling fan is maintained at the startup rotation speed (e.g., 4500 rpm), it is changed to the target rotation speed (e.g., 3500 rpm). The startup rotation speed depends on the characteristics of the cooling fan.

Under the normal fan startup control, a process of standing by until a given period of time (e.g., three seconds) elapses after the supply of the above control signal is carried out. When the given period of time elapses, the value of the control signal is changed from the startup rotation speed (e.g., 4500 rpm) to the target rotation speed (e.g., 3500 rpm).

Using the above control, the rotation speed of the cooling fan rises up to the startup rotation speed (e.g., 4500 rpm) and then lowers to the target rotation speed (e.g., 3500 rpm). Thus, the rotation speed varies greatly, which causes noise that makes a user uncomfortable.

FIG. 7 shows the silent fan startup control used in the present embodiment.

The silent fan startup control is performed when the cooling fan 22 is shifted from its off state to its rotating state at the target rotation speed. For example, the silent fan startup control is used to set the cooling fan 22 at the rotation speed of “Silent” in response to the power-on of the computer 10.

Under the silent fan startup control, the fan control unit 23, and specifically, the rotation speed setting unit 231 supplies the cooling fan 22 with a control signal having a first value for rotating the cooling fan 22 at the startup rotation speed (e.g., 4500 rpm). Supplying the cooling fan 22 with the control signal, the fan control unit 23 monitors the rotation speed of the cooling fan 22 using a rotation speed signal generated from the cooling fan 22. When the rotation speed of the cooling fan 22 is lower than the “Silent” rotation speed (e.g., 1500 rpm) of the target rotation speed and reaches a given rotation speed (referred to as the lowest rotation speed hereinafter) which allows the cooling fan 22 to rotate at a constant speed, the fan control unit 23 supplies the cooling fan 22 with a control signal having a second value for rotating the fan 22 at the “Silent” rotation speed (e.g., 1500 rpm) of the target rotation speed. Thus, the rotation speed of the cooling fan 22 smoothly rises up to the “Silent” rotation speed (e.g., 1500 rpm) of the target rotation speed from zero. Accordingly, noise can greatly be reduced.

If the normal fan startup control is carried out, the rotation speed of the cooling fan 22 rises from zero to the startup rotation speed (e.g., 4500 rpm) and then lowers to the target rotation speed, as indicated by the dotted line in FIG. 7. Under the silent fan startup control, the rotation speed of the cooling fan 22 does not vary as indicated by the dotted line in FIG. 7.

The “Silent” rotation speed and the lowest rotation speed each depend on the characteristics of the cooling fan 22.

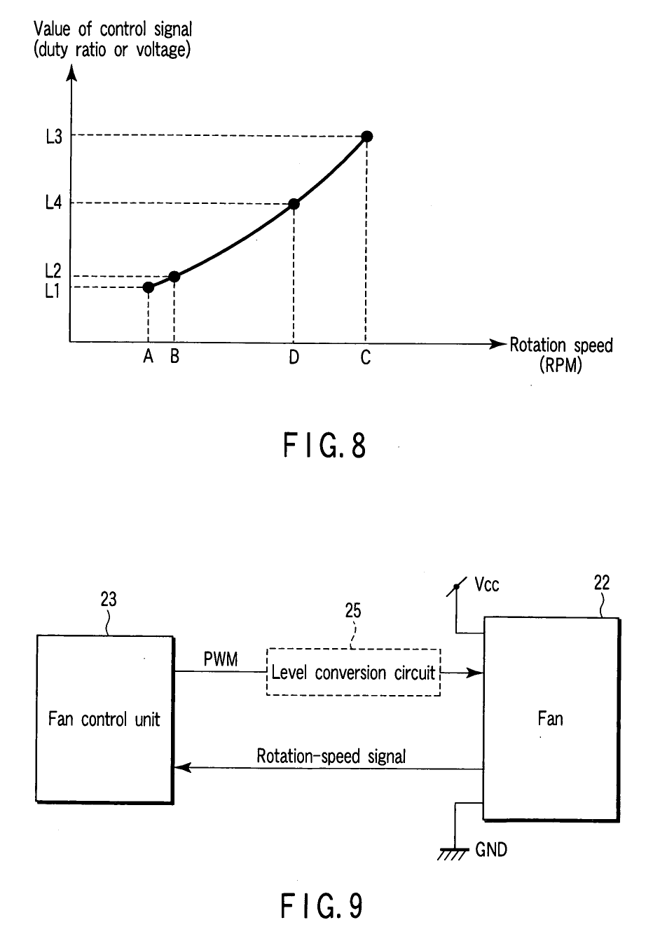

FIG. 8 shows a relationship between the rotation speed of the cooling fan 22 and the value of the control signal (duty ratio or voltage).

Assume now that the constant rotation speed at which the cooling fan 22 can stably rotate ranges from rotation speed A to rotation speed C, and rotation speed D is the startup rotation speed. The value of the control signal corresponding to rotation speed A is L1, and the value of the control signal corresponding to rotation speed C is L3. The value of the control signal corresponding to the startup rotation speed is L4.

For example, the lowest rotation speed is set at the minimum value A within the range of the constant rotation speed at which the cooling fan 22 can stably rotate, and the “Silent” rotation speed is set close to the minimum value A. In other words, the “Silent” rotation speed is set at rotation speed B which is slightly higher than the minimum value A and lower than the startup rotation speed D.

The lowest rotation speed can be set at a value that is slightly higher than the minimum value A since the following relationship has only to be satisfied:
Lowest rotation speed<Target rotation speed (“Silent” rotation speed)<Startup rotation speed

FIG. 9 shows a concrete example of connection between the fan control unit 23 and the cooling fan 22.

Favorably, a fan that can be driven directly by a pulse width modulation (PWM) signal (which is referred to as a PWM fan) is employed as the cooling fan 22. The PWM fan can be rotated at lower speed than the normal fan of a voltage-driven type.

The fan control unit 23 supplies the cooling fan 22 with a PWM signal as the above control signal to control the speed of the cooling fan 22. The rotation speed of the cooling fan 22 varies with the duty ratio of the PWM signal.

When the fan control unit 23 and the cooling fan 22 differ in power supply voltage from each other, the PWM signal output from the fan control unit 23 is supplied to the cooling fan 22 via a level conversion circuit 25. The level conversion circuit 25 converts the amplitude of the PWM signal from the power supply voltage of the fan control unit 23 to that of the cooling fan 22. If the power supply voltage of the fan control unit 23 is 3.3V and that of the cooling fan 22 is 5V, the level conversion circuit 25 converts the amplitude of the PWM signal from 3.3V to 5V.

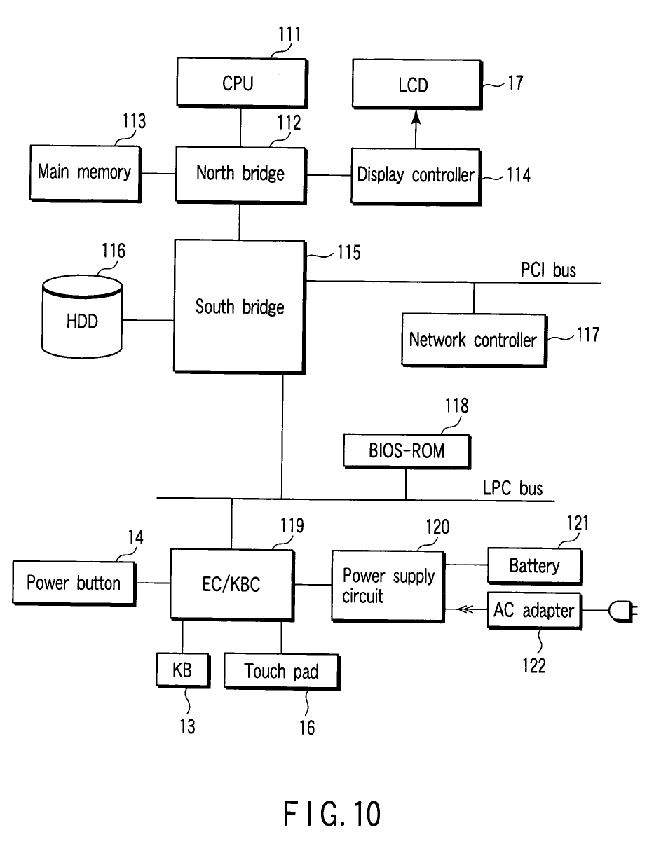

The system configuration of the computer 10 will be described with reference to FIG. 10.

The computer 10 includes a CPU 111, a north bridge 112, a main memory 113, a display controller 114, a south bridge 115, a hard disk drive (HDD) 116, a network controller 117, a flash BIOS-ROM 118, an embedded controller/keyboard controller IC (EC/KBC) 119, and a power supply circuit 120.

The CPU 111 is a processor for controlling the operation of each component of the computer 10. The CPU 111 executes an operating system and various application programs/utility programs. The operating system and programs are loaded into the main memory 113 from the HDD 116. The CPU 111 also executes a basic input output system (BIOS) stored in the flash BIOS-ROM 118. The BIOS is a program for controlling hardware.

The north bridge 112 is a bridge device for connecting a local bus of the CPU 111 and the south bridge 116. The north bridge 112 has a function of communicating with the display controller 114 via an accelerated graphics port (AGP) bus. The north bridge 112 incorporates a memory controller for controlling the main memory 113.

The display controller 114 controls the LCD 17 that is used as a display monitor of the computer 10. The display controller 114 has a 2D or 3D graphics computing function and serves as a graphics accelerator. The south bridge 115 is connected to a peripheral component interconnect (PCI) bus and a low pin count (LPC) bus.

The EC/KBC 119 is a one-chip microcomputer on which an embedded controller for managing power and a keyboard controller for controlling the keyboard (KB) 13 and the touch pad 16 are integrated. The EC/KBC 119 powers on/powers off the computer 10 by a user's depression of the power button 14 in association with the power supply circuit 120. The power supply circuit 120 generates system power, which is to be applied to the components of the computer 10, using a power from a battery 121 or an external power that is applied via an AC adapter 122.

In the system shown in FIG. 10, for example, the CPU 111, display controller 114, north bridge 112 and HDD 116 are heating devices.

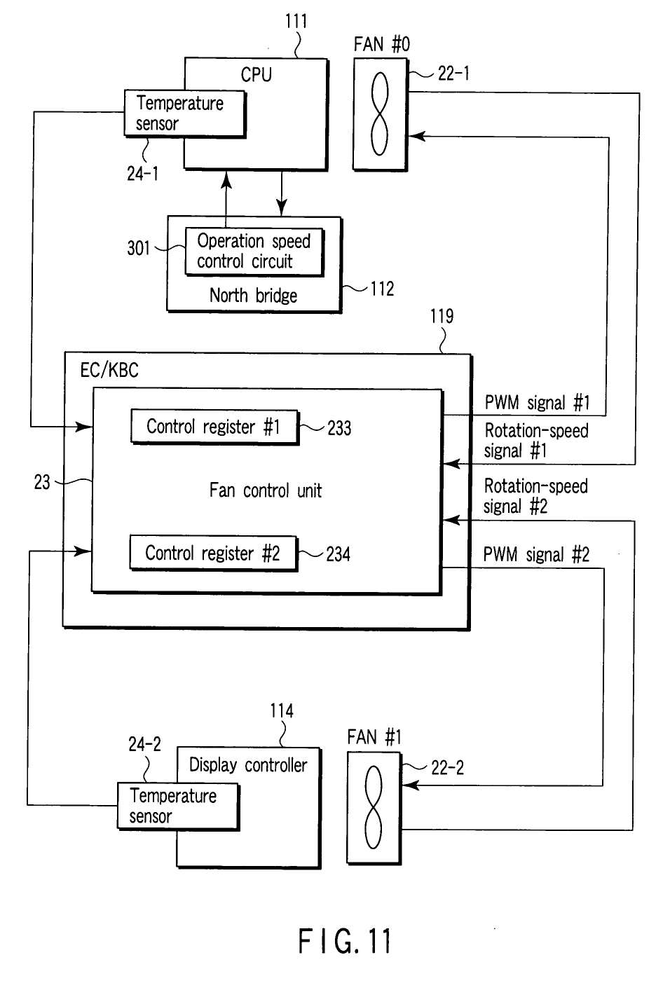

An example of a cooling control mechanism applied to the system shown in FIG. 10 will be described with reference to FIG. 11. Assume here that two cooling fans (FAN#0, FAN#1) cool the CPU 111 and display controller 114.

In FIG. 11, a cooling fan (FAN#0) 22-1 cools the CPU 111 and a cooling fan (FAN#1) 22-2 cools the display controller 114. The cooling fans 22-1 and 22-2 are each implemented by the PWM fan described above with reference to FIG. 9. The temperature of the CPU 111 and that of the display controller 114 are sensed by temperature sensors 24-1 and 24-2, respectively.

The fan control unit 23 is provided in, for example, the EC/KBC 119 and configured to control the two cooling fans 22-1 and 22-2. More specifically, the fan control unit 23 controls the rotation speed of the cooling fan 22-1 using a first PWM signal (PWM#1) and receives a rotation speed signal #1 from the cooling fan 22-1. The fan control unit 23 also controls the rotation speed of the cooling fan 22-2 using a second PWM signal (PWM#2) and receives a rotation speed signal #2 from the cooling fan 22-2.

The fan control unit 23 includes two control registers 233 and 234. The BIOS sets a parameter group for controlling the cooling fan 22-1 in the control register 233, and sets a parameter group for controlling the cooling fan 22-2 in the control register 234.

The north bridge 112 includes an operation speed control circuit 301. The operation speed control circuit 301 is a circuit for controlling the operation speed of the CPU 111. The operation speed control circuit 301 varies the operation speed of the CPU 111 stage by stage by changing the frequency of a clock signal of the CPU 111 or by performing a throttling control to operate the CPU 111 intermittently. The CPU 111 can be cooled not only by the cooling fan 22-1 but also by both the cooling fan 22-1 and the operation speed control circuit 301.

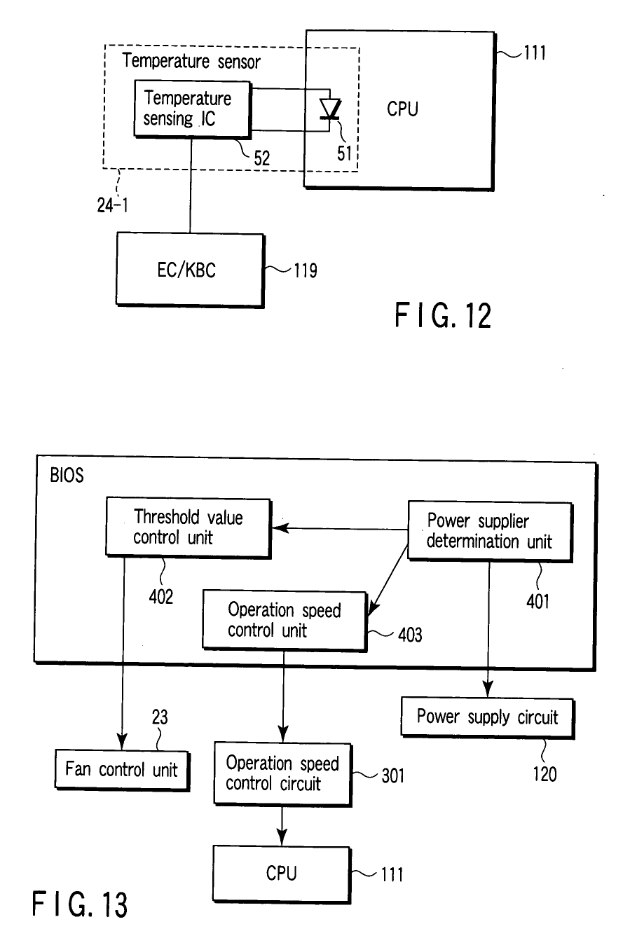

FIG. 12 shows an example of the temperature sensor 24-1.

The temperature sensor 24-1 includes a diode 51 and a temperature sensing IC 52. The diode 51 is mounted on or built in the CPU 111. The value of current flowing through the diode 51 varies with the temperature of the CPU 111. The temperature sensing IC 52 converts the value of current into data that represents the temperature of the CPU 111.

The cooling control operation of the CPU 111, which is performed by the BIOS, will be described with reference to FIG. 13.

The BIOS includes a power supplier determination unit 401, a threshold value control unit 402 and an operation speed control unit 403 as function modules (software modules) for performing the cooling control operation. The cooling control operation is performed in performance mode or power-saving mode. The performance mode is a cooling mode in which system performance has higher priority than power saving. The power-saving mode is a cooling mode in which power saving has higher priority than system performance. The performance mode is selected when the computer 10 is driven by an external power supply, and the power-saving mode is selected when the computer 10 is driven by the battery 121.

The power supplier determination unit 401 communicates with the power supply circuit 120 and determines which of the battery 121 and the external power supply drives the computer 10.

The threshold value control unit 402 controls the threshold value corresponding to the temperature range of the above “Low” speed, in accordance with the type of a driving power supply of the computer 10. More specifically, when the computer 10 is driven by the external power supply (performance mode), the threshold value corresponding to the temperature range of the “Low” speed is set to a predetermined first value. When the computer 10 is driven by the battery 121 (power-saving mode), the threshold value corresponding to the temperature range of the “Low” speed is set to a predetermined second value. The second value is larger than the first value.

When the computer 10 is driven by the battery 121, there is a strong possibility that the rotation speed of the cooling fan 22-1 will be maintained at “Silent” and the power consumption of the cooling fan 22-1 can be suppressed.

When the computer 10 is driven by the battery 121 (power-saving mode), the operation speed control unit 403 controls the operation speed control circuit 301 and performs an operation speed control process to decrease the operation speed of the CPU 111 in accordance with the temperature of the CPU 111 sensed by the temperature sensor 24-1.

The temperature of the CPU 111 that starts to perform the operation speed control process is set at a value that is lower than a threshold value (second value) corresponding to the temperature range of the “Low” speed in power-saving mode. For example, it is set at a threshold value (first value) corresponding to the temperature range of the “Low” speed in performance mode. Thus, the operation speed control process starts during which period the cooling fan 22-1 is rotating at the rotation speed of “Silent” and this period can be lengthened.

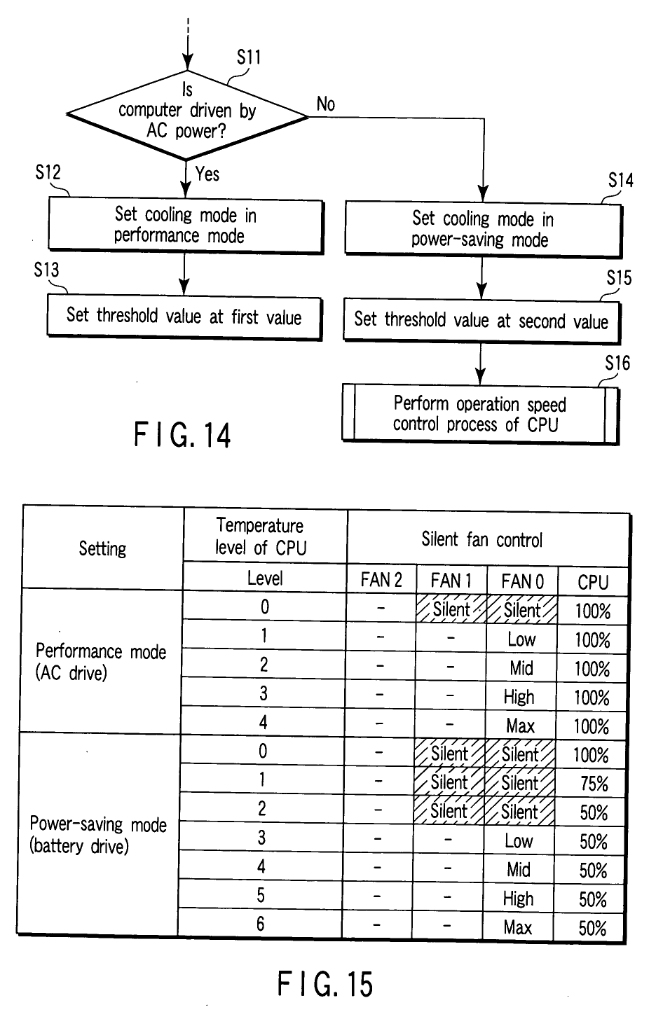

FIG. 14 is a flowchart of a procedure for the cooling control operation.

The BIOS first determines whether the computer 10 is driven by AC power, or whether the computer 10 is driven by an external power supply (block S11).

If the computer 10 is driven by an external power supply (YES in block S11), the BIOS sets the cooling mode in performance mode and sets the threshold value corresponding to the temperature range of “Low” speed in the above first value (Blocks S12 and S13).

If the computer 10 is driven by the battery 121 (NO in block S11), the BIOS sets the cooling mode in power-saving mode and sets the threshold value corresponding to the temperature range of “Low” speed in the above second value (Blocks S14 and S15). The BIOS performs the operation speed control process of the CPU 111 (block S16).

FIG. 15 is a table that defines a relationship between the temperature of the CPU and the rotation speed of each of the cooling fans in both the performance and power-saving modes. This table is managed by the BIOS.

In the performance mode, the temperature of the CPU 111 is managed by five temperature ranges of temperature levels 0 to 4. When the temperature falls within the temperature range of temperature level 0, the rotation speed of the cooling fan (FAN#0) 22-1 is set at “Silent”. When the temperature falls within the temperature range of temperature level 1, the rotation speed of the cooling fan (FAN#0) 22-1 is set at “Low”. When the temperature falls within the temperature range of temperature level 2, the rotation speed of the cooling fan (FAN#0) 22-1 is set at “Middle”. When the temperature falls within the temperature range of temperature level 3, the rotation speed of the cooling fan (FAN#0) 22-1 is set at “High”. When the temperature falls within the temperature range of temperature level 4, the rotation speed of the cooling fan (FAN#0) 22-1 is set at “Max”. Even though the operation speed control process is not performed but the temperature of the CPU 111 falls within any of temperature levels 0 to 4, the CPU 111 operates at 100% operation speed at all times.

In the power-saving mode, the temperature of the CPU 111 is managed by seven temperature ranges of temperature levels 0 to 6. When the temperature falls within the temperature ranges of temperature level 0 to 2, the rotation speed of the cooling fan (FAN#0) 22-1 is set at “Silent”. When the temperature falls within the temperature range of temperature level 3, the rotation speed of the cooling fan (FAN#0) 22-1 is set at “Low”. When the temperature falls within the temperature range of temperature level 4, the rotation speed of the cooling fan (FAN#0) 22-1 is set at “Middle”. When the temperature falls within the temperature range of temperature level 5, the rotation speed of the cooling fan (FAN#0) 22-1 is set at “High”. When the temperature falls within the temperature range of temperature level 6, the rotation speed of the cooling fan (FAN#0) 22-1 is set at “Max”.

In the power-saving mode, when the temperature of the CPU 111 falls within the temperature range of temperature level 1, the operation speed control process decreases the operation speed of the CPU 111 to 75% of the maximum operation speed. When the temperature falls within the temperature ranges of temperature levels 2 to 6, the operation speed control process decreases the operation speed of the CPU 111 to 50% of the maximum operation speed.

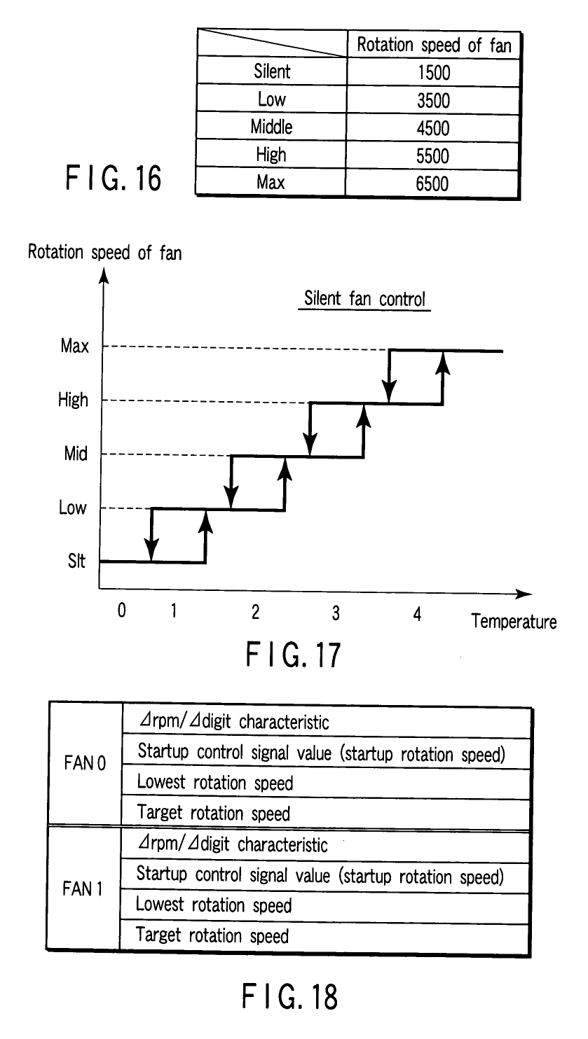

FIG. 16 shows an example of the rotation speeds of the fan, which correspond to “Silent”, “Low”, “Middle”, “High” and “Max”.

The BIOS determines the target rotation speed of the cooling fan 22-1 on the basis of the temperature of the CPU 111 sensed by the temperature sensor 24-1 and the table shown in FIG. 15. The BIOS sets data for designating the target rotation speed in the fan control unit 23. Needless to say, the target rotation speed of the cooling fan 22-1 can be determined by the fan control unit 23.

FIG. 17 shows an example of a transition of the rotation speed of the fan corresponding to the performance mode.

Assume here that the threshold value (first threshold value) used when the rotation speed of the fan increases and the threshold value (second threshold value) used when the rotation speed decreases differ from each other for each boundary between the rotation speeds. The second threshold value is set lower than the first threshold value.

When the temperature of the heating device such as the CPU and the display controller falls within a considerably lower-level temperature range of temperature level 0, the fan rotates at rotation speed “Silent”. When the temperature of the heating device reaches the first threshold value corresponding to temperature level 1 (the upper limit of the temperature range of temperature level 1), the rotation speed of the fan is changed from “Silent” to “Low”. When the temperature reaches the first threshold value corresponding to temperature level 2 (the upper limit of the temperature range of temperature level 2), the rotation speed of the fan is changed from “Low” to “Middle”.

When the temperature of the heating device starts to lower below the second threshold value of temperature level 2 (the lower limit of the temperature range of temperature level 2), the rotation speed of the fan is changed from “Middle” to “Low”. When the temperature of the heating device lowers further below the second threshold value of temperature level 1 (the lower limit of the temperature range of temperature level 1), the rotation speed of the fan is changed from “Low” to “Silent”.

As described above, the threshold value (first threshold value) used when the rotation speed of the fan increases and the threshold value (second threshold value) used when the rotation speed decreases are defined for each boundary between the rotation speeds. It is thus possible to prevent the rotation speed of the fan from being frequently switched between adjacent two rotations speeds.

A parameter group set in the fan control unit 23 by the BIOS will be described with reference to FIG. 18.

As described above, a parameter group for controlling the cooling fan (FAN#0) 22-1 is set in the control register 233 of the fan control unit 23, and a parameter group for controlling the cooling fan (FAN#1) 22-2 is set in the control register 234 of the fan control unit 23.

The parameter group set in the control register 233 includes a Δrpm/Δdigit characteristic, a startup control signal value (or startup rotation speed), the lowest rotation speed, and a target rotation speed.

The Δrpm/Δdigit characteristic indicates how much the rotation speed of the cooling fan (FAN#0) 22-1 varies with the variation of control data for designating the duty ratio of a PWM signal. On the basis of the Δrpm/Δdigit characteristic, the fan control unit 23 controls the duty ratio of the PWM signal. The startup control signal value (or startup rotation speed) indicates a value (duty ratio) of a control signal necessary for rotating the cooling fan (FAN#0) 22-1 at the above startup rotation speed. The lowest rotation speed indicates, for example, the minimum value of the rotation speed range capable of rotating the cooling fan (FAN#0) 22-1 at constant speed.

The Δrpm/Δdigit characteristic, startup control signal value (or startup rotation speed), lowest rotation speed and target rotation speed are also set in the control register 234.

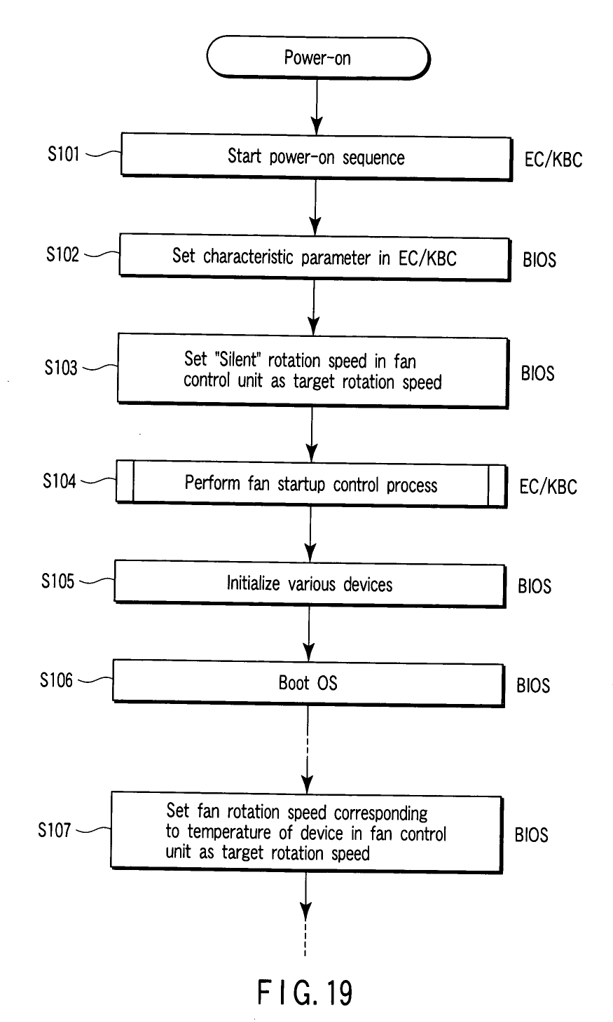

A procedure for performing a cooling control process by the computer 10 will be described with reference to the flowchart shown in FIG. 19.

When a user turns on the power switch 14, the EC/KBC 119 starts a power-on sequence for powering on the computer 10 (block S101). The components of the computer 10 are therefore supplied with operating power. The CPU 111 executes the BIOS.

The BIOS sets the characteristic parameters (Δrpm/Δdigit characteristic, startup control signal value, and lowest rotation speed) in the control registers 233 and 234 of the EC/KBC 119 and sets the rotation speed of the fan corresponding to “Silent” in the control registers 233 and 234 as a target rotation speed (blocks S102 and S103). The fan control unit 23 of the EC/KBC 119 performs a silent fan startup control process to shift each of the cooling fans 22-1 and 22-2 from its off state to a state in which it rotates at the rotation speed of “Silent” (block S104).

The BIOS initializes each device (block S105) and then boots up the operating system (block S106). Then, the BIOS performs a process of setting the rotation speed of the fan corresponding to the temperature of the CPU 111 in the EC/KBC 119 as the target rotation speed of the cooling fan 22-1 and a process of setting the rotation speed of the fan corresponding to the temperature of the display controller 114 in the EC/KBC 119 as the target rotation speed of the cooling fan 22-2 (block S107).

The process of each of blocks S103 and S107 can be performed by the fan control unit 23 in the EC/KBC 119.

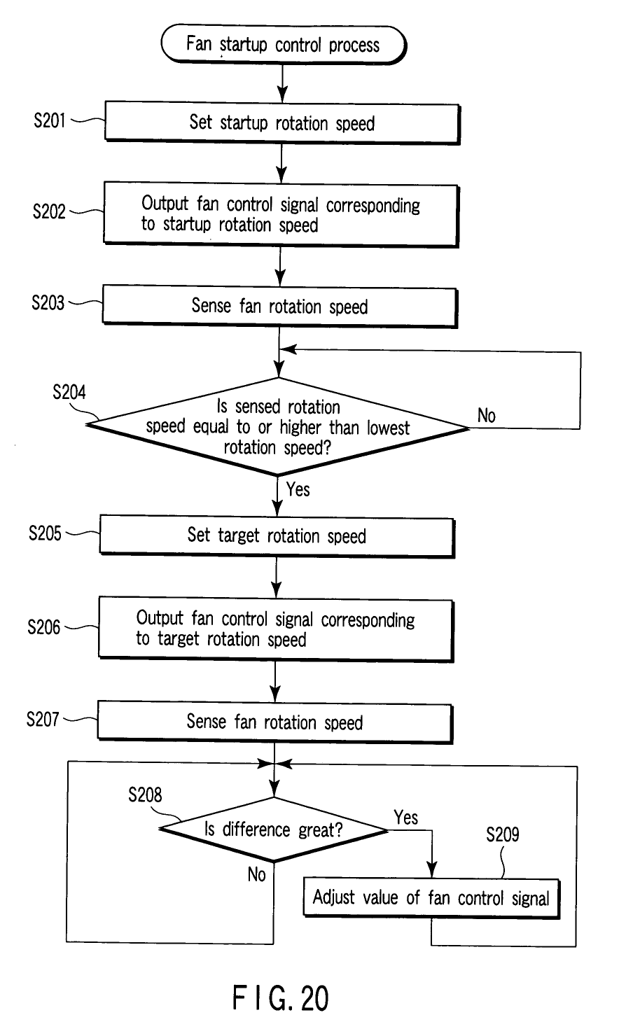

A procedure for performing a silent fan startup control process in block S104 shown in FIG. 19 will be described with reference to the flowchart shown in FIG. 20.

First, the EC/KBC 119 sets the startup rotation speed in the fan control unit 23 (block S201). The fan control unit 23 supplies the cooling fan 22-1 with a control signal having a value (duty ratio or voltage) corresponding to the startup rotation speed (block S202). The fan control unit 23 senses the rotation speed of the cooling fan 22-1 using a rotation speed signal supplied from the cooling fan 22-1 (block S203) and determines whether the rotation speed of the cooling fan 22-1 is the above lowest rotation speed or higher (block S204). The fan control unit 23 stands by until the rotation speed of the cooling fan 22-1 reaches the lowest rotation speed.

When the rotation speed of the cooling fan 22-1 is the lowest rotation speed or higher (YES in block S204), the EC/KBC 119 sets the target rotation speed (rotation speed corresponding to “Silent”) in the fan control unit 23 (block S205). The fan control unit 23 supplies the cooling fan 22-1 with a control signal having a value (duty ratio or voltage) corresponding to the target rotation speed (rotation speed corresponding to “Silent”) (block S206). As has been described with reference to FIG. 7, therefore, the rotation speed of the cooling fan 22-1 smoothly rises from zero to the target rotation speed (rotation speed corresponding to “Silent”).

The fan control unit 23 senses the rotation speed of the cooling fan 22-1 using a rotation speed signal supplied from the cooling fan 22-1 (block S207) and determines whether a difference between the rotation speed of the cooling fan 22-1 and the target rotation speed (rotation speed corresponding to “Silent”) is greater than a given value (block S208). If the difference is greater than the given value (YES in block S208), the fan control unit 23 increases or decreases the value (duty ratio or voltage) of the control signal on the basis of the difference and the Δrpm/Δdigit characteristic (block S209).

The rotation speed of the fan is therefore set in the rotation speed corresponding to “Silent”.

The fan control unit 23 also performs the processes of blocks S201 to S209 for the cooling fan 22-2.

In the embodiment of the invention described above, when the rotation speed of a cooling fan reaches the lowest rotation speed, the value of a control signal is switched from a control signal value corresponding to the startup rotation speed to a control signal value corresponding to the target rotation speed. Consequently, noise generated when the cooling fan starts to operate can adequately be reduced, thereby achieving great quietness.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a main body;
a heating device provided in the main body;
a cooling fan provided in the main body, which cools the heating device; and
a fan control unit provided in the main body, which supplies the cooling fan with a control signal having a first value for rotating the cooling fan at a given rotation speed that is higher than a target rotation speed, and which supplies the cooling fan with a control signal having a second value for rotating the cooling fan at the target rotation speed when a rotation speed of the cooling fan reaches a given rotation speed which is lower than the target rotation speed and which allows the cooling fan to rotate at a constant speed.

2. The information processing apparatus according to claim 1, wherein the fan control unit is configured to monitor the rotation speed of the cooling fan while supplying the cooling fan with the control signal having a first value.

3. The information processing apparatus according to claim 1, wherein the fan control unit is configured to monitor the rotation speed of the cooling fan using a rotation speed signal output from the cooling fan.

4. The information processing apparatus according to claim 1, wherein the given rotation speed is one of a minimum value within a rotation speed range which allows the cooling fan to rotate at a constant speed and a specific value close to the minimum value.

5. The information processing apparatus according to claim 1, wherein the control signal is a pulse width modulation (PWM) signal.

6. The information processing apparatus according to claim 1, wherein the heating device is a central processing unit (CPU).

7. The information processing apparatus according to claim 1, wherein the heating device is a display controller.

8. The information processing apparatus according to claim 1, further comprising a temperature sensor provided in the main body, which senses a temperature of the heating device, and
wherein the fan control unit is configured to control the rotation speed of the cooling fan in accordance with the temperature of the heating device sensed by the temperature sensor.

9. A fan control method of controlling a cooling fan provided in an information processing apparatus, the method comprising:
supplying the cooling fan with a control signal having a first value for rotating the cooling fan at a given rotation speed that is higher than a target rotation speed; and
supplying the cooling fan with a control signal having a second value for rotating the cooling fan at the target rotation speed when a rotation speed of the cooling fan reaches a given rotation speed which is lower than the target rotation speed and which allows the cooling fan to rotate at a constant speed.

10. The fan control method according to claim 9, wherein the supplying the cooling fan with a control signal having a second value includes monitoring the rotation speed of the cooling fan while supplying the cooling fan with the control signal having a first value.

11. The fan control method according to claim 10, wherein the rotation speed of the cooling fan is monitored using a rotation speed signal output from the cooling fan.

12. The fan control method according to claim 9, wherein the given rotation speed is one of a minimum value within a rotation speed range which allows the cooling fan to rotate at a constant speed and a specific value close to the minimum value.
